(19) United States
(12) Patent Application Publication
(10) Pub. No.: US 2011/0123886 A1
(43) Pub. Date: May 26, 2011

(54) METHOD AND ARRANGEMENT TO ENHANCE THE PREHEATING OF A FUEL CELL SYSTEM

(75) Inventors: Tero Hottinen, Lohja (FI); Kim Äström, Kirkkonummi (FI); Timo Kivisaari, Helsinki (FI); Jukka Göös, Helsinki (FI)

(73) Assignee: WARTSILA FINLAND OY, Vaasa (FI)

(21) Appl. No.: 12/987,444

(22) Filed: Jan. 10, 2011

Related U.S. Application Data
(63) Continuation of application No. PCT/FI2009/050619, filed on Jul. 9, 2009.

(30) Foreign Application Priority Data
Jul. 10, 2008 (FI) 20085720

(51) Int. Cl. H01M 8/04

(52) U.S. Cl. 429/429

(57) ABSTRACT

The disclosure relates to a system and a method for enhancing the preheating of a fuel cell system having at least one fuel cell unit whose fuel cells are provided with an anode side, a cathode side and an electrolyte provided therebetween, as well as a connecting plate set between each of the fuel cells. In operation, safety gas flowing on the anode side is heated, at least for the most part (e.g., greater than 50%), in the fuel cell unit by thermal energy contained in a gas flowing on the cathode side.

### RELATED APPLICATIONS

This application claims priority as a continuation application under 35 U.S.C. §120 to PCT/FI2009/050619, which was filed as an International Application on Jul. 9, 2009, designating the U.S., and which claims priority to Finnish Application 20085720 filed in Finland on Jul. 10, 2008. The entire contents of these applications are hereby incorporated by reference in their entireties.

### FIELD

A method to enhance the preheating of a fuel cell system is disclosed. A fuel cell system is also disclosed, and can include at least one fuel cell unit whose fuel cells are provided with an anode side, a cathode side and an electrolyte provided therebetween, as well as a connecting plate set between each of the fuel cells.

### BACKGROUND INFORMATION

Fuel cell systems, such as those which operate at a high temperature, can involve a relatively long preheating process for starting up the actual operation. SOFC (solid oxide fuel cell) and MCFC (molten carbonate fuel cell) type fuel cell systems, can involve heating to an operating temperature which may take as long as several hours. The heating of a fuel cell continues up to a temperature level that enables activation of normal operation. The term preheating is used here in reference to conditions, in which the fuel cell system is heated from a cold inactive condition to a temperature level specified for activating a normal operating mode or in which the temperature of a fuel cell system is only returned to this level, for example after a momentary disruption in operation. In the case of an SOFC type fuel cell, the final temperature of a preheating process can be within a range of 500-600° C. Ultimately, the actual operating temperature for the cells settles within, for example, the range of 600-1000° C. (i.e., the heating of a fuel cell system continues after the activation, even while the preheating itself has been terminated).

The inefficient preheating and the long start-up cycle of a fuel cell system can result in a number of drawbacks. For example, the heating can consume a lot of energy. In the case of an SOFC type fuel cell, throughout the start-up cycle, there is also need for a safety gas for the anode side with its associated costs. The long start-up cycle of a fuel cell system can also undermine its usability. Its use is limited to, for example, producing a consistent basic load type of electricity or heat either as a stationary infrastructure type installation or in connection with large mobile units such as ships. Instead, it has a poor applicability for small mobile operations, and also for operations involving a rapidly activated power production. The same issues apply largely to MCFC type fuel cell systems, as well.

In a heating process taking place on the anode side, a specific issue is the high flammability of hydrogen or any other gas component employed as a reductive component. Special supervision is involved for temperatures, as well as for the concentration in various parts of the assembly, in order not to exceed values matching an auto-ignition point that constitutes an explosion hazard. In practice, the concentration of a safety gas is controlled in such a way that the mixture flowing out of a possible leakage—fuel cells can leak a certain amount of gases to their vicinity—shall retain its properties below the values matching the auto-ignition point—primarily below a LEL (Lower Explosive Limit); (i.e., a lower auto-ignition point). For example, in the case of a hydrogen-nitrogen mixture at room temperature, this represents a hydrogen concentration of about 6%. As temperature rises, this threshold concentration becomes gradually even lower. Thus, the hydrogen concentration has quite strict limits imposed thereupon. Even moderately minor variations for example in hydrogen concentrations bring the parameters of a gas mixture too close to values corresponding to what is in excess of the above-mentioned ignition point. Consequently, when a safety gas is heated on the anode side, there is a risk of exceeding the hydrogen concentration or the safety gas temperature, for example due to malfunction incidents, resulting in a potential explosion hazard. Independent heating systems for the anode side, along with possible safety features included therein, can also incur considerable equipment costs while occupying space, as well.

### SUMMARY

A method for enhancing the preheating of a fuel cell system is disclosed having at least one fuel cell unit with plural fuel cells, each fuel cell having an anode side, a cathode side, an electrolyte between the anode and cathode, and having a connecting plate between the fuel cells, the method comprising: providing a safety gas flowing on the anode side; and heating the safety gas, at least for the most part, in the fuel cell unit by thermal energy contained in a gas flowing on the cathode side.

An arrangement for enhancing the preheating of a fuel cell system is disclosed, the arrangement comprising: at least one fuel cell unit having plural fuel cells, each provided with an anode side, a cathode side, and an electrolyte between the anode side and the cathode side; a connecting plate set between the fuel cells; and a gas path for safety gas to flow on the anode side such that, at least for the most part, the safety gas will be heated in the fuel cell unit by thermal energy contained in a gas flowing on the cathode side during operation.

### BRIEF DESCRIPTION OF THE DRAWINGS

Exemplary embodiments will now be described in more detail with reference to the accompanying drawings, in which:

FIG. 1 shows schematically one exemplary arrangement of the disclosure, wherein heating of a cathode side is also utilized for heating of an anode side; and

FIG. 2 is a close-up view of an area A in FIG. 1, showing a heat transfer process useful in fuel cells according to the disclosure.

### DETAILED DESCRIPTION

According to exemplary embodiments of the disclosure, an effective internal heat transfer capability of a fuel cell is utilized for the preheating of an anode side. Exemplary fuel cell surfaces are structurally quite massive, thus demanding plenty of thermal energy for heating up to operating temperature. Indeed, its internal heat transfer has been designed to operate efficiently. The discharge gas of an anode side travels, for example, in a heat cascade back through the very heat exchangers it is coming from.

Accordingly, in a normal operating condition, the gases heated in and discharging from fuel cells warm up the incoming gas on a countercurrent principle. This heat transfer effect, as well as the heat transfer capability of fuel cells between their anode and cathode sides, are applied to the heating of the anode side safety gas and, at the same time, additionally to the heating of the anode side structures of a fuel cell unit by using the heated cathode side flow as an immediate heat source.

According to exemplary embodiments, the heating of the anode side components of a fuel cell system is based, at least for the most part, on the thermal energy transferred from the cathode side to the anode side by means of fuel cells. Thus, the anode side heating occurs specifically in a fuel cell unit.

More specifically, the heat proceeds, for example, both across the electrolyte from cathode to anode and from the cathode of one individual fuel cell, and for example from air flowing on that side, directly by way of a connecting plate to the anode of another individual fuel cell, and for example into a safety gas flowing on the anode side of the connecting plate. The gas mixture (e.g., air), flowing on the cathode side, can be heated first (e.g., with electric heaters disposed within the air flow). The heated air is delivered to fuel cell surfaces for bringing it to flow in the flow channels of the cathode side. In a fuel cell, the airborne heat proceeds efficiently into the anode side and further into a safety gas flowing in the flow channels of the anode side. As a result, the heating of a fuel cell system can be both simplified and expedited for bringing the system to operating temperature.

An exemplary beneficial solution is achieved by concurrently providing the anode side with a safety gas circulation. This can accomplish both a reduction of the anode gas consumption and an enhanced utilization of thermal energy on the anode side.

The disclosure provides a solution which offers a multitude of benefits over known solutions. In terms of energy costs, savings are created both by a shortened start-up cycle and by means for providing enhanced heat transfer. In terms of equipment, there is a beneficial possibility of reducing the number of heating units set for heating the anode side or reducing the powers thereof or dismissing the same completely. Benefits can thereby be provided in terms of both equipment costs and in terms of space used by the system. The system adjustability can also be improved by virtue of a simpler mode of heating, as well as by a permanently minor temperature difference between the cathode and anode sides. In addition, by providing the anode side with a safety gas circulation according to an exemplary embodiment of the disclosure, there is an ability to cut back energy costs by virtue of both decreasing heat losses and providing a more efficient heat transfer than before.

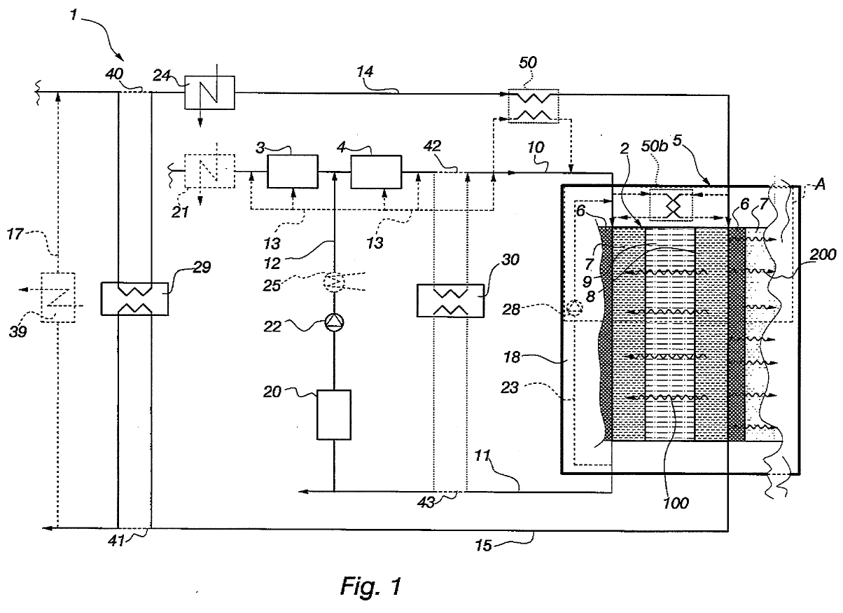

FIG. 1 shows an exemplary fuel cell system 1 in a highly schematic view. A fuel cell unit 5 included therein comprises one or more fuel cell stacks containing (e.g., consisting of) successive series-connected fuel cells 2, featuring an anode side 7, a cathode side 8 and an electrolyte 9 provided therebetween, as well as a connecting plate 6, a so-called interconnect, set between individual fuel cells. The fuel cell system can be configured as a sort of bipolar plate. For example, it can be located on the cathode side of one individual fuel cell 2 and on the anode side of another individual fuel cell 2, and functions therebetween both as an electrical conductor between the fuel cells and as a separator wall for gases, blocking the uncontrolled cell-to-cell flow of gases. The fuel system can provide a flow channel system for gases flowing in a fuel cell, both on the anode side and on the cathode side. For the sake of clarity, FIG. 1 only shows a single fuel cell 2 from a fuel cell stack.

In this application, the anode side 7 refers both to anode electrodes included in the fuel cells 2 of the fuel cell units 5 and, from the perspective of fuel, to components for conducting the fuel within the confines of the fuel cell units 5 to the anodes of actual individual fuel cells. Respectively, the cathode side 8 refers to cathode electrodes, as well as to components provided for conducting air to cathodes within the confines of the fuel cell units 5. Similarly, the anode side and respectively the cathode side can be considered to include flow channels for gas flows, provided on the anode side and respectively on the cathode side in the connecting plates 6 set between the fuel cells 5. Thus, flow channels can be included on the anode side for the flow of safety gas and fuel, and on the cathode side for the flow of air.

In addition, for feeding a safety gas to the anode 7, there are provided supply means, represented here solely by a supply line 10. Likewise, for draining the fuel cell unit of a safety gas outgoing from the anode side 7, there are provided discharge means, represented here solely by a discharge line 11. Respectively, for feeding air to the cathode side 8, there are provided supply means, which are here represented by a supply line 14.

Supply both to the anode side 7 and to the cathode side 8 can occur, for example, by using the above-mentioned flow channels provided in the connecting plate 6, by means of which the supply flows can be evenly distributed across an entire area of an anode electrode and respectively a cathode electrode prior to proceeding to an actual anode/cathode electrode. In order to drain the fuel cell unit 5 of a gas outgoing from the cathode, discharge means are provided, as represented by a discharge line 15. For the sake of clarity, other supply means and discharge means are not depicted in this context. On the anode side, or the fuel side, there are also provided possible pretreatment devices for treating a fuel-forming gas mixture prior to its delivery to fuel cells. Such devices include, for example, a prereformer 4 and a desulphurizer 3 or a like gas scrubbing device or pretreatment unit.

For preheating the fuel cells 2, there are provided heating means for the heating of both the anode side safety gas and the cathode side air. The heating of air present on the cathode side 8 can be handled either directly by means of an in-line heater or indirectly by way of a heat exchanger. In FIG. 1, the means for heating and regulating the temperature of air circulating on the cathode side are represented by a heating unit 24 fitted in the supply line 14. The anode side can be respectively provided with known heating devices 21 for warming up the safety gas prior to its delivery to fuel cells.

In known arrangements, considerable amounts of heat are also lost with the heat of an outgoing gas, as the hot gas used for bilateral heating of a fuel cell is conducted out after flowing through and making its exit from the fuel cell. At the same time, this increases the amount of energy involved in a start-up cycle. The consumption of a safety gas used on the anode side results not only in a long heating cycle but also in significant costs. Furthermore, the arrangement involves close supervision to preclude the development of an excessive temperature difference between the anode and cathode sides. A further issue is caused by the above-described issues, and relates to the auto-ignition of hydrogen and can be prominent in anode side heating systems.

In order to mitigate the above-explained issues, the anode side heating according to exemplary embodiments disclosed herein is provided through the intermediary of a fuel cell by means of thermal energy obtained from the cathode side. Thus, the heat contained in a gas circulating on the cathode side 8 is now utilized according to exemplary embodiments of the disclosure for heating the anode side 7.

The heating of air flowing on the cathode side 8 can be provided in a variety of methods. The above-mentioned, directly applied heating option can be implemented for example by an electrically operated heating device. Use can be made for example of electric heaters disposed within the air flow. In the case of a burner, on the other hand, the heating of air can be based on regulating the exhaust gas flow of a burner by means of separate heat transfer surfaces, or the exhaust gases of a burner can even be applied for the direct heating of air which flows through the process components of a fuel cell. In the case of burners, however, it can be advisable to conduct the heating indirectly if it is desirable to securely block the access of excessively hot exhaust gases to fuel cells or to prevent excessive moisture on the cathode side of fuel cells. Other sources of heat are also viable when the heating of air is conducted by applying indirect heating by means of a heater equipped with heat transfer surfaces or by means of a heat exchanger. Moreover, the system can also be supplied with heat by using an assembly of electric heaters and start-up burners. Another embodiment can provide for the recovery of heat from the outgoing warm air and its transfer into the incoming cold air for preheating the latter by means of heat exchangers 29. This process can also be by-passed as shown by lines 40, 41. It should be stressed, however, that the present disclosure is not limited to any given method or combination of methods for heating the cathode side gas.

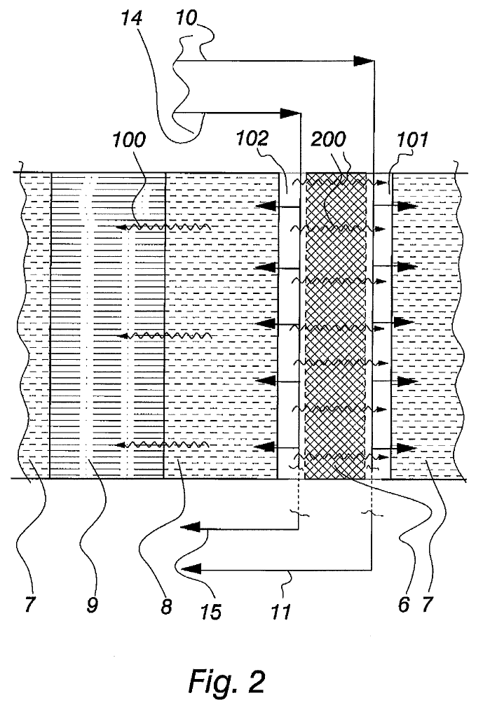

The cathode side gas mixture comprises, for example, air, either as such or appropriately pretreated, for example filtered and dried. The heated air is delivered to the cathode side using, for example, flow channels 102 formed in the connecting plate 6, as visualized in the close-up view 2 of an area A in FIG. 1. Respectively, on the anode side the supply of a safety gas, as well as that of a fuel at an appropriate time, is conducted by way of flow channels indicated by reference numeral 101. The air flowing on the cathode side, being now in a heated condition, is set at a temperature clearly higher than the air to be supplied to the anode side and yet to be heated. Accordingly, the airborne heat passes in a fuel cell stack 5 from anode side to cathode side, both in individual fuel cells internally and for example from the cathode side 8 of one fuel cell directly to the anode side of another fuel cell. Thus, heat passes first of all between adjacent cathode and anode sides across the electrolyte 9 as illustrated with arrows 100. Secondly, the heat passes directly across the connecting plate 6 between flow channels of the anode side 7 and the cathode side 8 present therein, as illustrated with arrows 200. Hence, the fuel cell stacks contain (e.g., consist of) a plurality of individual, successively series-arranged single fuel cells 2 and the connecting plates 6 therebetween, the latter being provided with for example adjacent fuel/air flow channels—both being represented in FIG. 2 by flow channels 101 and 102. The material thicknesses between anode and cathode sides can be at a minimum just in the connecting plate and the flows can be at their maximum intensity, thus providing the best possible heat transfer efficiency.

Thus, the connecting plate components are highly suitable for effective use as gas/gas heat exchangers. Hence, by making use of the good heat transfer properties of fuel cell surfaces, and for example the conveniently small-size dimensions of the connecting plate 6 between flow channels, a portion of the heat transferred into the cathode side air flow can be passed effectively into the anode side safety gas flow. The heat transfer can be further intensified by selecting the connecting plate material to be as highly heat conductive as possible. It is also beneficial, according to exemplary embodiments of the disclosure, that the disposition, dimensions and design of flow channels present therein be conducted to achieve as good a heat transfer as possible across the connecting plate.

The safety gas which circulates onto the anode side 7 warms up effectively and smoothly in fuel cells. After flowing out of the fuel cells, it can now be used for the transfer of heat also to other equipment components of the anode side (i.e., the fuel side). Such components include particularly a prereformer 4 and other possible fuel pretreatment or scrubbing devices 3. By virtue of the anode side heating effected in fuel cells, it is possible to abandon completely the separate heating devices 21 for heating components included in the anode side. It is also viable to organize, even during a preheating cycle, the recovery of heat from the outgoing warm air and to transfer it into the incoming cold air for preheating the same by means of heat exchangers 30. This process can also be by-passed as indicated by lines 42, 43.

Exemplary embodiments of the disclosure enable temperature to be increased smoothly in various parts of a fuel cell system and exclusively by means of heaters 24, 29 employed on the anode side. By virtue of an effective heat transfer and gas flow taking place in fuel cells, the temperature difference between anode and cathode sides remains at the same time well under control while the heating becomes more effective. It should be noted that the temperature difference between an anode electrode and a cathode electrode may not be allowed to become excessive, not even during the course of heating. The maximum temperature difference value is, for example, about 200° C. (e.g., ±10%, or lesser or greater). By applying exemplary methods according to the disclosure, this temperature difference can be managed effectively at the same time and the temperature difference can be maintained securely within a desired range. As a result of effective heating, the system has its heating time shortened and the consumption of energy is reduced during a start-up cycle. At the same time, the consumption of safety gas is also reduced. In a general sense, it is an improved usability for the fuel cell which is also achieved.

The arrangement provided by the disclosure is by no means limited to the immediately above described embodiments, the sole purpose of which is only to explain principles of the disclosure in a simplified manner and construction.

According to another exemplary embodiment of the disclosure, the flow of safety gas outgoing from the anode side 7 can be adapted to flow in an intensified manner in a heat cascade with respect to the flow of safety as coming in the anode side 7. This can be established in the connecting plate 6 by means of such a relative disposition of the anode side flow channel provided therein that an efficient heat transfer is created between the cool incoming and heated outgoing anode side flows. This extra aspect of the disclosure can be likewise implemented by means of a heat exchanger external of the fuel cell unit 5 positioned just upstream of the fuel cell unit 5 with regard to the supply flow. In other words, the incoming supply flow of safety gas is heated by means of warmed-up safety gas just after its exit from the fuel cell unit 25, in FIG. 1 by means of the heat exchanger 30.

According to an exemplary embodiment of the disclosure, the heat transfer between anode and cathode sides can be adapted to proceed not only in a heat transfer taking place in connection with the fuel cell unit 5 but also completely outside the same prior to a delivery into the fuel cell unit 5. In FIG. 1, reference numeral 50 designates a heat transfer device to represent a desired transfer of heat between the cathode and anode side supply flows as early as upstream of the fuel cell unit 5 externally thereof. Thereby, the temperature difference between cathode and anode sides can be simultaneously equalized for precluding the occurrence of an excessive temperature difference in the structures of a fuel cell unit. This has a distinct positive effect in terms of the durability of the structures.

On the other hand, in exemplary solutions according to the disclosure, the anode and cathode side pipe systems and structures relevant thereto can be designed with particular regard to heat transfer in view of providing a flow-to-flow heat transfer as efficient as possible. Thus, the heat transfer is possible even without using separate heat transfer devices for this purpose.

The internal heat transfer of a fuel cell unit, upstream of fuel cells, which is represented in FIG. 1 with a heat transfer device 50b, can be implemented in practice for example by providing the in-flow channels of anode and cathode flows in close contact. The flow can be worked out both for gas distribution members and for the support structures of a fuel cell unit in view of providing an efficient channel-to-channel heat transfer. An exemplary concept and benefit is the possibility of effectively utilizing a support structure, which can be included in any event, for equalizing temperature differences between anode and cathode flows. In addition, the surface finish of gas flow channels can be worked out for promoting the creation of appropriate swirling (turbulence) capable of enhancing convection heat transfer. Selecting a surface finish for the channels is nevertheless made, for example, by considering also pressure losses in order to avoid an excessive increase thereof.

Alternatively, the heat transfer arrangement can be implemented for example with a jointed structure assembled by a welding principle. The anode and cathode flow channels can be divided into a plurality of side-by-side and alternating segments for maximizing the heat transfer area. The structure can be for example a gas-turbulence promoting panel type member or pipe and a heat transfer device with an internal shell side. The flow possessing a higher thermal current—in this case the cathode gas—is for example placed on the shell side. Moreover, in a structure such as this, the addition of ribs for maximizing the heat transfer is more convenient than in a structure worked out as mentioned above. Likewise, the implementation of thin separating walls is easier.

The heat transfer element 50, 50b can be provided by using known heat exchangers. It is possible to use both a tubular, lamellar, as well as a plate heat exchanger. The number of units can be one or more, connected in series or in parallel. The heat exchanger can be operated on a countercurrent-flow, concurrent-flow or cross-flow heat transfer or a combination thereof. The selection is determined for example by available space, as well as by the directions of gases flowing into the fuel cell—in other words, whether the operation is carried out by a cross-flow, countercurrent-flow or concurrent-flow stack. The arrangement according to an exemplary embodiment of the disclosure can also be implemented by means of a regenerative heat exchanger. In this case, however, can be desireable to ensure a high-quality sealing and to preclude the build-up of an explosive gas mixture resulting from possible leaks. In addition, with regard to the unit's reliability, the auxiliary power needed for the operation of a regenerative heat exchanger presents an extra reliability issue as compared to other types of heat exchangers.

In any event, the temperature difference in a heat exchanger of the disclosure between cathode and anode side gas flows prior to a delivery to fuel cells can be of such a magnitude that it is often enough to design the flow channel system to be efficient from the standpoint of heat transfer. Even this is sufficient for limiting the temperature difference reliably below a desired maximum value—e.g., about 200° C. (±10% or lesser or greater)—prior to a delivery to fuel cells.

According to yet another exemplary embodiment of the disclosure, there is further provided a safety gas recirculation on the anode side 7, whereby the costs relating to the use of a safety gas can be reduced in quite an extraordinary manner. A certain percentage of the total flow of safety gas, which streams through the anode side and exits the fuel cells, is diverted along a line 12 in FIG. 1 to make another run through the anode side by splitting off the safety gas flow discharging from the fuel cells and by joining it at an appropriate location with the safety gas supply proceeding to the fuel cells. The higher the percentage of safety gas to be recirculated, the higher the percentage of primary safety gas supply to the feeding line which can be totally omitted. At the same time, the working efficiency of thermal energy is enhanced even further.

The percentage of recirculated safety gas flow from its total flow is selectable in a desired manner basically over the entire range of 0-100%. For example, not less than a half of the safety gas is recirculated back onto the anode side, most conveniently more than 75%. Thus, in the process of regulating the recirculation percentage, it is possible to consider changes and relative ratios in the concentrations of various safety gas components. In any event, the amount of free hydrogen H2 at each temperature should be maintained below a concentration matching the explosive point. Similarly, in the process of regulating the degree of recirculation, it is possible to consider the enrichment of an inert component (i.e., in this case nitrogen), in the safety gas. At the same time, as long as the primary supply is maintained constant in terms of its amount and composition, it is possible to conduct the adjustment of the amount of a reductive component solely by means of adjusting the degree of recirculation.

The recirculation of a safety gas flowing on the anode side provides a means for making a particularly efficient use of the heat transferred thereto in a fuel cell, since the amount of heat flowing out of the system along with the safety gas can be minimized. Hence, the heat of a safety gas can be further distributed over the fuel side components in an energy-efficient manner and thereby it is possible achieve lesser-than-before heat losses also in the heating of these components to their operating temperature. Heat transfer is further enhanced by the fact that, by the recirculation of a safety gas, its total flow rate in a fuel cell unit can be increased while its absolute consumption is diminished. The increased flow efficiency equals a more efficient-than-before heat transfer both in a fuel cell unit and other anode side equipment external of the fuel cell unit. In FIG. 1, reference numeral 13 is used to designate possible optional routes, for the passage of a recirculated safety gas. The safety gas can be used, for example, for heating the prereformer 4 and the desulphurizer 3 or other possible fuel pretreatment equipment.

By means of exemplary embodiments of the disclosure, the separate heating of an anode side or fuel side is not necessary, and it is possible that the separate heating devices 21 for fuel side components be abandoned completely. Similarly, the possible heating devices 25 for a recirculation line can be omitted. On the other hand, it is possible to provide means for treating a recirculation-bound safety gas prior to its diversion back into the circulation. It can be especially beneficial to separate hydrogen which has reacted with oxygen (i.e., in practice to remove water vapor from the safety gas prior to its delivery back to the anode). This way, the safety gas can be kept as dry as possible and at the same time the percentage of hydrogen can be increased in the total recirculation-bound gas flow.

In addition, the amount of unused safety gas (i.e., that of the primary safety gas flow), can be minimized even more efficiently by using active regulation thereon. Thus, for example, the primary supply amount of safety gas is here regulable in a line 10 pursuant to how much of the reductive component of a safety gas is spent on the node side, as well as pursuant to what is the percentage of recirculation. This adjustment can be conducted merely by regulating the mass flow of a primary safety gas without further interference with a composition of the gas.

Because an inert gas (e.g., nitrogen) is not spent for reduction, in the recirculation of a safety gas, such inert gas shall be circulated quantitatively as well as also proportionally more than hydrogen as some of the latter is spent in the course of flowing through the anode side. Consequently, the percentage of nitrogen in a safety gas has a tendency to rise. This, in turn, can be compensated for by additionally adjusting also the composition of a primary safety gas. According to an exemplary embodiment of the disclosure, the hydrogen, which has oxidized in a fuel cell on the anode side, is replaced not by a normal safety gas mixture but, instead, by a hydrogen mixture concentrated to a desired degree, or the percentage of hydrogen is increased in an unspent primary safety gas. In practice, for example, it is possible to employ, in separate bottles, nitrogen and hydrogen or nitrogen and an enriched hydrogen mixture, the supply and mixing ratio of which are controlled as desired or as specified.

According to yet another exemplary embodiment of the disclosure, the recirculation of a safety gas can also be carried out at least partially inside the fuel cell unit 5. A portion of the safety gas is not necessarily expelled at all from the entire unit 5 but, immediately upon exiting the anode side flow channels, it will be diverted along a dash-dot marked line 23 with the assistance of a possible pump 28 or the like booster directly back into the anode side supply flow. This enables, at the same time, enhancing the flow of a safety gas in the actual fuel cell. Likewise, for example, the temperature difference between cathode and anode sides can be made as small as possible. However, a portion of the safety gas flow can, for example, be routed by way of a circulation external of the fuel cell unit (e.g., for performing any desired dewatering of the safety gas).

Dash-dot lines are also used in FIG. 1 to designate a possible air circulation line 17 on the cathode side, as well as heater 39 provided therein. The air discharging from the cathode side is conducted by way of the line 17 to be recirculated to a desired degree onto the cathode side of a fuel cell. Thereby, for example the heat, which is still bonded to the heating air, is maximized in the heating process of fuel cells. Likewise, the recirculation of cathode side air can be used for lowering the demands of the heat exchanger 24 functioning as a preheater of air.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for enhancing the preheating of a fuel cell system having at least one fuel cell unit with plural fuel cells, each fuel cell having an anode side, a cathode side, an electrolyte between the anode and cathode, and having a connecting plate between the fuel cells, the method comprising:
providing a safety gas flowing on the anode side; and
heating the safety gas, at least for the most part, in the fuel cell unit by thermal energy contained in a gas flowing on the cathode side.

2. A method according to claim 1, wherein the heating of a safety gas flowing on the anode side is based solely on heating performed in the fuel cell unit by thermal energy contained in a gas flowing on the cathode side.

3. A method according to claim 1 comprising:
transferring additional heat from the gas of the cathode side to a gas flowing on the anode side prior to a delivery of the gas on the anode side to the fuel cell unit.

4. A method according to claim 1, wherein a certain percentage within a range of 0-100% of the safety gas flowing on the anode side is resupplied to the anode side of the fuel cells.

5. A method according to claim 4, comprising:
diverting the safety gas upon discharge from the fuel cell unit to flow by way of at least one fuel pretreatment device, included in equipment of the anode side, for heating of the safety gas.

6. A method according to claim 5, comprising performing prereforming and/or desulphurizing in said pretreatment device.

7. A method according to claim 1, comprising:
discharging the safety gas flow from the anode side via a heat cascade relative to the safety gas flow arriving at the anode side for heating the arriving flow.

8. An arrangement for enhancing the preheating of a fuel cell system, the arrangement comprising:
at least one fuel cell unit having plural fuel cells, each provided with an anode side, a cathode side, and an electrolyte between the anode side and the cathode side;
a connecting plate set between the fuel cells; and
a gas path for safety gas to flow on the anode side such that, at least for the most part, the safety gas will be heated in the fuel cell unit by thermal energy contained in a gas flowing on the cathode side during operation.

9. An arrangement according to claim 8, wherein the gas path is configured so that heating of the safety gas flowing on the anode side will occur solely in the fuel cell unit by thermal energy contained in a gas flowing on the cathode side.

10. An arrangement according to claim 8, wherein the fuel cell unit is configured to transfer heat from a gas of the cathode side to a gas flowing on the anode side prior to a delivery of the anode side gas to the fuel cell unit.

11. An arrangement according to claim 8, comprising:
a gas path wherein during operation a percentage within a range of 0-100% of the safety gas, which has been conducted through the anode side of the fuel cell unit and has been heated therein, is adapted to be recirculated back to the anode side of the fuel cell unit.

12. An arrangement according to claim 8, comprising:
at least one fuel pretreatment device, included in the anode side of the fuel cell, for heating safety gas discharged from the fuel cell unit.

13. An arrangement according to claims 12, wherein said pretreatment device comprises:
a prereformer and/or a desulphurizer.

14. An arrangement according to claim 8, comprising:
a heat cascade for heating safety gas flow arriving at the anode side with a safety gas flow discharged by the anode side.

15. A method according to claim 1, wherein a certain percentage within a range of more than 50% of the safety gas flowing on the anode side is re-supplied to the anode side of the fuel cells.

16. A method according to claim 1, wherein a certain percentage within a range of more than 75% of the safety gas flowing on the anode side is re-supplied to the anode side of the fuel cells.
